(19) United States
(12) Patent Application Publication
(10) Pub. No.: US 2006/0286862 A1
(43) Pub. Date: Dec. 21, 2006

(54) REUSABLE INSULATING AND SEALING STRUCTURE INCLUDING TETHERED CAP AND ASSOCIATED METHODS

(75) Inventors: Paul W. LUBINSKY, Palm Coast, FL (US); Marie T. Lubinsky, Palm Coast, FL (US); James L. ZAHNEN, Ormond Beach, FL (US); Roy E. JAZOWSKI, Ormond Beach, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Homac Mfg. Company, Ormond Beach, FL (US)

(21) Appl. No.: 11/420,547

(22) Filed: May 26, 2006

Related U.S. Application Data
(63) Continuation-in-part of application No. 11/026,978, filed on Dec. 30, 2004, now Pat. No. 7,094,094.
(60) Provisional application No. 60/685,441, filed on May 27, 2005.

(51) Int. Cl. H01R 13/52

(52) U.S. Cl. 439/521; 439/587; 439/798; 439/814

(57) ABSTRACT

A reusable insulating and sealing structure may include an insulating tube and a frusto-conical seal having an enlarged diameter open distal end carried by an open distal end of the insulating tube and having a reduced diameter open proximal end extending into the insulating tube. The reduced diameter open proximal end may be resiliently deformable to accommodate a range of sizes of cable ends therethrough. The reusable insulating and sealing structure may also include a removable seal closure cap for removable positioning in the enlarged diameter open distal end of the frusto-conical seal, and an integrally molded tether connecting the removable seal closure cap to the frusto-conical seal adjacent the enlarged diameter open distal end thereof. The closure cap and tether permit the insulating and sealing structure to be sealed when a cable is not extending therethrough and thus permit the insulating and sealing structure to be reused.

### RELATED APPLICATIONS

This application is based upon U.S. Provisional Patent Application No. 60/685,441 filed on May 27, 2005 and is also a continuation-in-part of U.S. patent application Ser. No. 11/026,978 filed on Dec. 30, 2004, the entire disclosures of both of which are incorporated herein by reference.

### FIELD OF THE INVENTION

The invention relates to the field of electrical components, and, more particularly, to an insulating structure to be used with an electrical connector, and associated methods.

### BACKGROUND OF THE INVENTION

Underground and submersible junction bus connectors are widely used in electrical power distribution systems. One type of such connector is offered under the designation SWEETHEART® by Homac Mfg. Company of Ormond Beach, Fla., the assignee of the present invention. The SWEETHEART® connector is a cast or welded aluminum connector including a bus, or bar, portion and a series of tubular posts extending outwardly from the bus portion. The posts have an open upper end to receive one or more electrical conductors. A threaded bore is provided in the sidewall of the post, and which receives a fastener to secure the electrical conductor within the upper end of the post. An insulating coating is provided on the lower portion of the posts and bus of the connector. In addition, EPDM insulating sleeves may be used to provide waterproof seals for the posts. U.S. Pat. Nos. 6,347,966; 6,345,438 and 6,262,567 disclose various embodiments of such bus and post connectors.

Homac also manufacturers a PAB series of “Flood Seal”® Rubberized Aluminum Bar connectors suitable for direct burial, handhole or pedestal applications. The RAB connector includes a generally rectangular aluminum body having a plurality of spaced apart cable-receiving passageways therein. These cable-receiving passageways are blind holes, that is, they extend inward, but do not extend fully through the connector body. The blind hole is useful to provide sealing at the lower end of the connector body for the later molding of the rubber insulating cover.

The connector body also has a fastener-receiving passageway intersecting each cable-receiving opening. A fastener is provided in each fastener receiving passageway. Each fastener comprises a blunt end for bluntly contacting a corresponding insulation-free cable end. In particular, the blunt end may be a ball bottom screw end that helps break up aluminum oxides of the insulation-free cable end to ensure better electrical contact.

As the name states, the RAB connector includes a rubber insulating cover over the connector body. The insulating cover includes integrally molded inlets for both the cable-receiving openings and fastener-receiving openings. An insulating boot, such as a cable size adaptor or Rocket may be provided for the cable-receiving inlet, and a sealing cap may be received over the screw in the fastener-receiving inlet.

U.S. Pat. No. 6,688,921 to Borgstrom et al. discloses a connector similar to the Homac RAB series connector. In place of EPDM, the patent uses a thermoplastic elastomer (TPE) that combines the properties of thermoplastic with the performance characteristics of a thermoset rubber. The use of TPE enables the molding to further form sealing plugs and cable size adaptors attached to the cover with respective tethers.

Michaud Electrical Equipment of France offered an insulation displacing connector (IDC) including a generally rectangular connector body, and transverse cable-receiving and fastener-receiving passageways. More particularly, the connector body included a backwall having a pattern of sharp ridges thereon to pierce the insulation on the cable end as the end of the fastener engages and presses against the cable end from the opposite side. To be sure the cable end is fully pressed onto the sharp ridges, a plastic viewing window is provided opposite the inlet of the cable-receiving passageway. Accordingly, an installer can view the cable end to be sure the insulation has been pierced. The window is adjacent the rubber cover. Unfortunately, the Michaud IDC device is likely to leak at the window since the seal is only a mechanical seal. In addition, insulation displacement technology may not be suitable for larger cable sizes with thicker insulation coverings.

The Bergstrom et al. '921 patent also discloses an insulating boot inserted into each tubular cable inlet. Unfortunately, once cut to fit a particular cable, there is no way to reuse the insulating boot to seal the cable inlet with the cable removed. Instead a new insulating boot needs to be inserted to seal the tubular cable inlet. A connector offered by Thomas & Betts Corporation under the designation Elastimold® products includes a dust cap to seal the enlarged open end of the insulating boot during shipping; however, this dust cap is discarded after first use of the insulating boot and cannot be reused to reseal the insulating boot.

### SUMMARY OF THE INVENTION

In view of the foregoing background it is therefore an object of the invention to provide a reusable insulating and sealing structure for an electrical cable end to be positioned in an electrically conductive body of an electrical connector.

This and other objects, features and advantages in accordance with the present invention are provided by a reusable insulating and sealing structure comprising an insulating tube and a frusto-conical seal having an enlarged diameter open distal end carried by an open distal end of the insulating tube and having a reduced diameter open proximal end extending into the insulating tube. The reduced diameter open proximal end may be resiliently deformable to accommodate a range of sizes of cable ends therethrough. The reusable insulating and sealing structure may also include a removable seal closure cap for removable positioning in the enlarged diameter open distal end of the frusto-conical seal, and an integrally molded tether connecting the removable seal closure cap to the frusto-conical seal adjacent the enlarged diameter open distal end thereof. Accordingly, the closure cap and tether permit the insulating and sealing structure to be sealed when a cable is not extending therethrough and thus permit the insulating and sealing structure to be reused.

The insulating tube and the frusto-conical seal may be integrally formed as a monolithic unit. The removable seal closure cap may comprise a flange, and a cylindrical plug having a closed end extending from the flange. The removable seal closure cap may further comprise a gripping member extending within the cylindrical plug and beyond the flange. In some advantageous embodiments, the flange, cylindrical plug, gripping member, and tether may be integrally formed as a monolithic unit. In other embodiments, the flange, cylindrical plug, gripping member, tether, and frusto-conical seal may all be integrally formed as a monolithic unit. In still other embodiments, the flange, cylindrical plug, gripping member, tether, frusto-conical seal, and insulating tube may be integrally formed as a monolithic unit.

The frusto-conical seal may comprise a material having a percent elongation to yield of not less than about 300 percent, and, more preferably, not less that about 400 percent. The frusto-conical seal may, for example, comprise a silicone material, a thermoplastic material, a thermosetting material or a thermoplastic elastomer (TPE) material. The open proximal end of the frusto-conical seal and an elasticity thereof may accommodate cable end sizes in a range of from one-quarter to seven-eights inch, for example.

A method aspect is for making a reusable insulating and sealing structure for an electrical cable end to be positioned in an electrically conductive body of an electrical connector. The method may include forming an insulating tube having an open proximal end to be positioned adjacent the electrically conductive body of the electrical connector and an open distal end opposite the open proximal end. The method may further include forming a frusto-conical seal having an enlarged diameter open distal end carried by the open distal end of the insulating tube and having a reduced diameter open proximal end extending into the insulating tube, the reduced diameter open proximal end being resiliently deformable to accommodate a range of sizes of cable ends therethrough. In addition, the method may include providing a removable seal closure cap for removable positioning in the enlarged diameter open distal end of the frusto-conical seal, and forming an integrally molded tether connecting the removable seal closure cap to the frusto-conical seal adjacent the enlarged diameter open distal end thereof.

### BRIEF DESCRIPTION OF THE DRAWINGS

FIG. 1 is a cross-sectional view of an embodiment of a reusable insulating and sealing structure for an electrical cable end in accordance with the invention.

FIG. 2 is a cross-sectional view of a portion of another embodiment of a reusable insulating and sealing structure for an electrical cable end in accordance with the invention.

FIG. 3 is a cross-sectional view of a portion of still another embodiment of a reusable insulating and sealing structure for an electrical cable end in accordance with the invention.

### DETAILED DESCRIPTION OF THE PREFERRED EMBODIMENTS

The invention will now be described more fully hereinafter with reference to the accompanying drawings in which preferred embodiments of the invention are shown. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout, and prime and multiple prime notations are used to indicate similar elements in alternative embodiments.

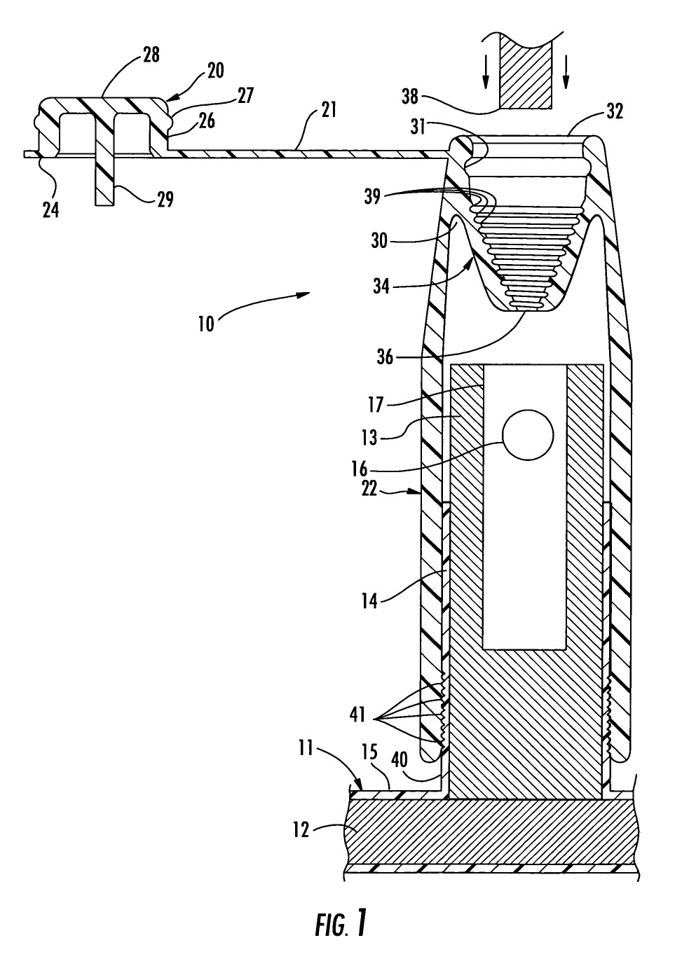

Referring now initially to FIG. 1, a reusable insulating and sealing structure 10 for an electrical cable end 38 in accordance with the invention is described. The reusable insulating and sealing structure 10 is illustratively used with an electrical connector 11 of the bus and post type, although it could be used in conjunction with other types of connectors as would be appreciated by those skilled in the art. The connector 11 includes a conductive bus 12 with a plurality of conductive posts 13 extending upwardly therefrom, with only one of the posts being shown for clarity of explanation. The bus 12 has an insulating covering 11 thereover, and the post 13 also has an insulating covering 14 extending partly thereover. A fastener receiving passageway 16 intersects the cable end receiving passageway 17 in the illustrated embodiment. A bus and post connector and associated method of manufacture, but without the reusable insulating and sealing structure, are disclosed in U.S. Pat. No. 6,347,966 assigned to the assignee of the present application and incorporated herein by reference in its entirety.

The insulating and sealing structure 10 includes a removable seal closure cap 20 connected by a flexible tether 21 to an exterior of a frusto-conical seal 34 having an enlarged diameter open distal end 32 carried by an open distal end 30 of the insulating tube 22 and having a reduced diameter open proximal end 36 extending into the insulating tube. The reduced diameter open proximal end 36 is preferably resiliently deformable to accommodate a range of sizes of cable ends therethrough. The insulating and sealing structure 10 may comprise a silicone material, for example, which has a high elasticity to accommodate different sized cable ends 38. Other thermoplastic or thermosetting materials may also be used. Thermoplastic elastomers (TPEs) may also be used.

The removable seal closure cap 20 includes a flange 24, a hollow cylindrical plug 26 having a closed end 28 extending from the flange, and a sealing lip 27 extending outwardly from the cylindrical plug. Of course, the plug 26 could be solid in other embodiments. The removable seal closure cap 20 also illustratively includes a gripping member or tab 29 extending within the hollow cylindrical plug 26 and beyond the flange 24. The gripping member 29 facilitates manual grasping or grasping using a suitable tool to permit removal or insertion of the closure cap 20. As will be appreciated by those skilled in the art, the flange 24, hollow cylindrical plug 26, and gripping member 29 may be integrally formed as a monolithic unit with the tether 21 and the frusto-conical seal 34. The removable boot closure cap 16 can be secured within the open outer or distal end 32 of the frusto-conical seal 34 to provide an environmental seal, and with the optional sealing lip 27 being inserted into the illustrated optional recess 31 at the distal end. Since the proximal end 36 is open, the removable seal closure cap and integral tether 21 are especially useful even during storage and shipping as will be appreciated by those skilled in the art.

The frusto-conical seal 34 may be considered being defined by a sidewall having a progressively decreasing diameter that terminates at the open proximal end 36 thereof. In the illustrated embodiment, the diameter of the frusto-conical seal 34, especially at the open proximal end 36 may accommodate a plurality of different sizes of cable ends 38, without requiring the cutting of the seal as will be appreciated by those skilled in the art. The inner surface of the seal 34 may optionally include a series of ridges or rings 39 in some embodiments. In addition, because the frusto-conical seal 34 comprises an elastically deformable material, it will deform and tightly adhere to the cable end 38 to form an environmental seal when the cable end is inserted therein. In other words, the frusto-conical seal 34 may serve as a cable size adaptor.

For example, the open proximal end 36 of the frusto-conical seal 34 and an elasticity thereof may accommodate sizes of cable ends 38 in a range of from one-quarter to seven-eights inch, corresponding to 6 gauge to 350Kcmil cable sizes. Other sizes may also be accommodated as will be appreciated by those skilled in the art. The frusto-conical seal 34 may comprises a material having a percent elongation to yield of not less than about 300 percent, and, more preferably not less than 400 percent.

The frusto-conical seal 34 may be environmentally sealed in at least two different ways. First, the removable seal closure cap 21 may provide the environmental seal when the cable end 38 is not present. And secondly, the frusto-conical seal 34 working in conjunction with the cable end 38 may provide the environmental seal when the cable end is present.

The insulating tube 22 further illustratively includes an open proximal end 40, opposite the distal open end 30. The open proximal end 40 includes a plurality of optional ridges or rings 41 on an interior thereof. The ridges 41 engage the insulating covering 14 around the conductive post 13.

The reusable insulating and sealing structure 10 may have a height of about 5.5 inches, a width of about 1.6 inches, and the tether 21 may have a length so that a center of the cap 20 is about 2.6 inches from a center of the seal 34. Of course, other sizes are also possible. The insulating tube 22 may be of a stiffer material than the frusto-conical seal 34, and/or vertical stiffening ribs may be added to the insulating tube. In other embodiments, two insulating and sealing structures 10 may be used in a back-to-back configuration for a splice as will be appreciated by those skilled in the art.

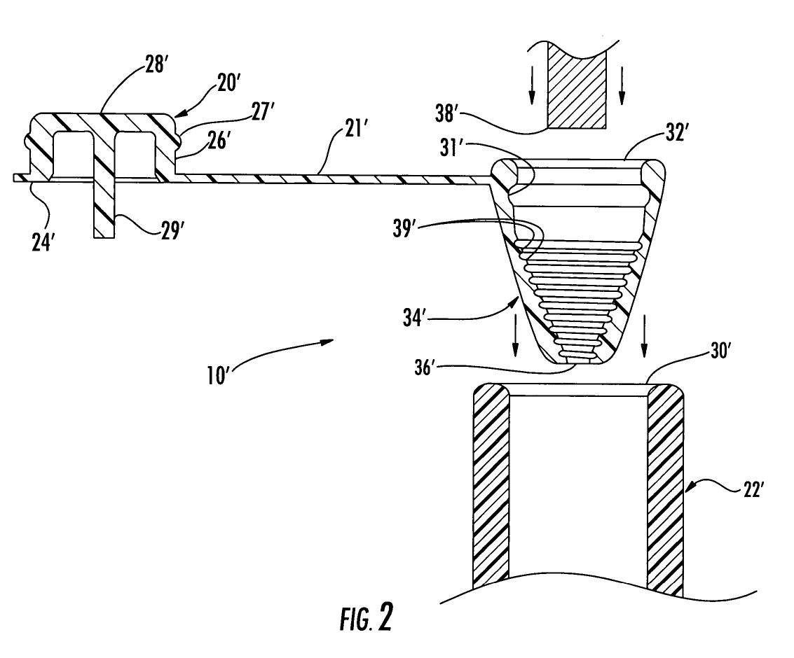

Referring now additionally to FIG. 2, an alternative embodiment of the insulating and sealing structure 10′ is described. The frusto-conical seal 34′ is formed or molded separately from the insulating tube 22′, and may be frictionally engaged therewith. Of course, in other embodiments, the frusto-conical seal 34′ may be joined to the insulating tube 22′ using various approaches, such as using adhesives or various welding techniques as will be appreciated by those of skill in the art.

In this embodiment, the insulating tube 22′ may be a cable receiving port of a Rubberized Aluminum Bar (RAB) connector, such as disclosed in U.S. Pat. No. 6,997,759 assigned to the assignee of the present invention, and the entire contents of which are incorporated herein by reference. The frusto-conical seal 34′ may be inserted into the tubular connector port being correspondingly sized and shaped for receiving the seal as will be appreciated by those of skill in the art. The frusto-conical seal 34′ may include other sealing features such as sealing ridges, not shown, to facilitate the forming and maintaining of an environmental seal with the open end 30′ of the insulating tube 22′. Those other elements, not specifically mentioned, are indicated with prime notation, are similar to the elements described above, and require no further discussion herein.

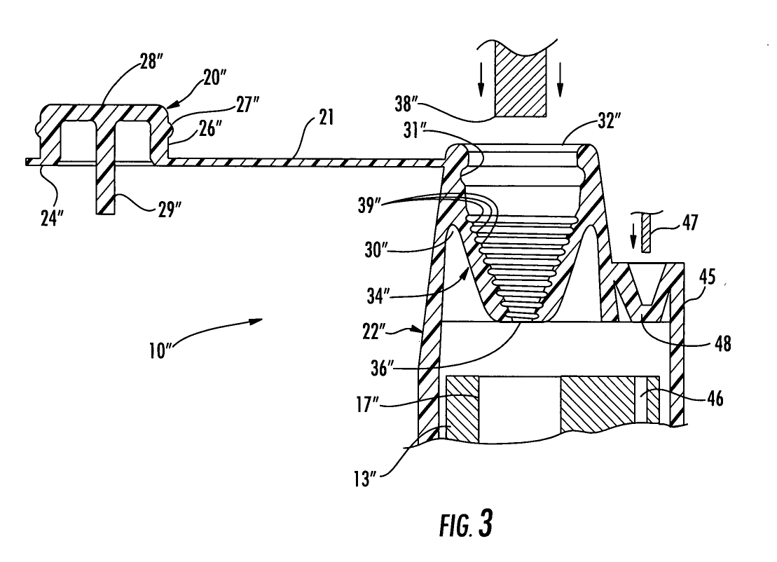

Turning now to FIG. 3, yet another embodiment of the reusable insulating and sealing structure 10″ is now described. In this embodiment, a smaller frusto-conical sealing structure 45 is added to the side of the main insulating tube 22″. The smaller frusto-conical sealing structure 45 is aligned with a smaller gauge wire opening 46 in the post 13″ so that a smaller gauge wire 47, such as for a streetlight, for example, may be connected as will be appreciated by those skilled in the art. In the illustrated embodiment the smaller sealing structure 45 has a puncturable proximal end 48, although in other embodiments, the end may be open. Indeed, for an open end embodiment, an integral tether and sealing cap as described above may optionally be provided. Those other elements, not specifically mentioned, are indicated with double prime notation, are similar to the elements described above, and require no further discussion herein. In still other embodiments, the proximal end 36″ of the frusto-conical seal 34″ could also be rupturable.

Returning again to FIG. 1, a method aspect is for making a reusable insulating and sealing structure 10 for an electrical cable end 38 to be positioned in an electrically conductive body 13, 12 of an electrical connector 11. The method may include forming an insulating tube 22 having an open proximal end 40 to be positioned adjacent the electrically conductive body 13, 12 of the electrical connector 11 and an open distal end 30 opposite the open proximal end. The method may further include forming a frusto-conical seal 34 having an enlarged diameter open distal end 32 carried by the open distal end 30 of the insulating tube 22 and having a reduced diameter open proximal end 36 extending into the insulating tube, the reduced diameter open proximal end being resiliently deformable to accommodate a range of sizes of cable ends therethrough. In addition, the method may include providing a removable seal closure cap 20 for removable positioning in the enlarged diameter open distal end 32 of the frusto-conical seal 34, and forming an integrally molded tether 21 connecting the removable seal closure cap to the frusto-conical seal adjacent the enlarged diameter open distal end thereof.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that other modifications and other embodiments are intended to be included within the scope of the following claims.

That which is claimed is:

1. A reusable insulating and sealing structure for an electrical cable end to be positioned in an electrically conductive body of an electrical connector, the reusable insulating and sealing structure comprising:
an insulating tube having an open proximal end to be positioned adjacent the electrically conductive body of the electrical connector and an open distal end opposite the open proximal end;
a frusto-conical seal having an enlarged diameter open distal end carried by the open distal end of said insulating tube and having a reduced diameter open proximal end extending into said insulating tube, the reduced diameter open proximal end being resiliently deformable to accommodate a range of sizes of cable ends therethrough;
a removable seal closure cap for removable positioning in the enlarged diameter open distal end of said frusto-conical seal; and
an integrally molded tether connecting said removable seal closure cap to said frusto-conical seal adjacent the enlarged diameter open distal end thereof.

2. The reusable insulating and sealing structure according to claim 1 wherein said insulating tube and said frusto-conical seal are integrally formed as a monolithic unit.

3. The reusable insulating and sealing structure according to claim 1 wherein said removable seal closure cap comprises a flange, and a cylindrical plug having a closed end extending from said flange.

4. The reusable insulating and sealing structure according to claim 3 wherein said removable seal closure cap further comprises a gripping member extending within said cylindrical plug and beyond said flange.

5. The reusable insulating and sealing structure according to claim 4 wherein said flange, cylindrical plug, gripping member, and tether are integrally formed as a monolithic unit.

6. The reusable insulating and sealing structure according to claim 5 wherein said flange, cylindrical plug, gripping member, tether, and frusto-conical seal are integrally formed as a monolithic unit.

7. The reusable insulating and sealing structure according to claim 5 wherein said flange, cylindrical plug, gripping member, tether, frusto-conical seal, and insulating tube are integrally formed as a monolithic unit.

8. The reusable insulating and sealing structure according to claim 1 wherein said frusto-conical seal comprises a material having a percent elongation to yield of not less than about 300 percent.

9. The reusable insulating and sealing structure according to claim 1 wherein said frusto-conical seal comprises a silicone material.

10. The reusable insulating and sealing structure according to claim 1 wherein said frusto-conical seal comprises a thermoplastic material.

11. The reusable insulating and sealing structure according to claim 1 wherein said frusto-conical seal comprises a thermosetting material.

12. The reusable insulating and sealing structure according to claim 1 wherein said frusto-conical seal comprises a thermoplastic elastomer (TPE) material.

13. The reusable insulating and sealing structure according to claim 1 wherein the open proximal end of said frusto-conical seal and an elasticity thereof accommodate cable end sizes in a range of from one-quarter to seven-eights inch.

14. A reusable insulating and sealing structure for an electrical cable end to be positioned in an electrically conductive body of an electrical connector, the reusable insulating and sealing structure comprising:
an insulating tube having an open proximal end to be positioned adjacent the electrically conductive body of the electrical connector and an open distal end opposite the open proximal end;
a frusto-conical seal integrally formed as a monolithic unit with said insulating tube and having an enlarged diameter open distal end carried by the open distal end of said insulating tube and having a reduced diameter open proximal end extending into said insulating tube, the reduced diameter open proximal end being resiliently deformable to accommodate a range of sizes of cable ends therethrough;
a removable seal closure cap for removable positioning in the enlarged diameter open distal end of said frusto-conical seal;
said removable seal closure cap comprising a flange, and a cylindrical plug having a closed end extending from said flange; and
a tether connecting said removable seal closure cap to said frusto-conical seal adjacent the enlarged diameter open distal end thereof.

15. The reusable insulating and sealing structure according to claim 14 wherein said removable seal closure cap further comprises a gripping member extending within said cylindrical plug and beyond said flange.

16. The reusable insulating and sealing structure according to claim 15 wherein said flange, cylindrical plug, gripping member, and tether are integrally formed as a monolithic unit.

17. The reusable insulating and sealing structure according to claim 15 wherein said flange, cylindrical plug, gripping member, tether, and frusto-conical seal are integrally formed as a monolithic unit.

18. The reusable insulating and sealing structure according to claim 14 wherein said frusto-conical seal comprises a material having a percent elongation to yield of not less than about 300 percent.

19. The reusable insulating and sealing structure according to claim 14 wherein said frusto-conical seal comprises at least one of a silicone material, a thermoplastic material, a thermosetting material, and a thermoplastic elastomer (TRE) material.

20. The reusable insulating and sealing structure according to claim 14 wherein the open proximal end of said frusto-conical seal and an elasticity thereof accommodate cable end sizes in a range of from one-quarter to seven-eights inch.

21. A method for making a reusable insulating and sealing structure for an electrical cable end to be positioned in an electrically conductive body of an electrical connector, the method comprising:
forming an insulating tube having an open proximal end to be positioned adjacent the electrically conductive body of the electrical connector and an open distal end opposite the open proximal end;
forming a frusto-conical seal having an enlarged diameter open distal end carried by the open distal end of the insulating tube and having a reduced diameter open proximal end extending into the insulating tube, the reduced diameter open proximal end being resiliently deformable to accommodate a range of sizes of cable ends therethrough;
providing a removable seal closure cap for removable positioning in the enlarged diameter open distal end of the frusto-conical seal; and
forming an integrally molded tether connecting the removable seal closure cap to the frusto-conical seal adjacent the enlarged diameter open distal end thereof.

22. The method according to claim 21 wherein the insulating tube and the frusto-conical seal are integrally formed as a monolithic unit.

23. The method according to claim 21 wherein the removable seal closure cap comprises a flange, and a cylindrical plug having a closed end extending from the flange.

24. The method according to claim 23 wherein the removable seal closure cap further comprises a gripping member extending within the cylindrical plug and beyond the flange.

25. The method according to claim 24 wherein the flange, cylindrical plug, gripping member, and tether are integrally formed as a monolithic unit.

26. The method according to claim 25 wherein the flange, cylindrical plug, gripping member, tether, and frusto-conical seal are integrally formed as a monolithic unit.

27. The method according to claim 25 wherein the flange, cylindrical plug, gripping member, tether, frusto-conical seal, and insulating tube are integrally formed as a monolithic unit.

28. The method according to claim 21 wherein the frusto-conical seal comprises a material having a percent elongation to yield of not less than about 300 percent.

29. The method according to claim 21 wherein the frusto-conical seal comprises at least one of a silicone material, a thermoplastic material, a thermosetting material, and a thermoplastic elastomer (TPE) material.

30. The method according to claim 21 wherein the open proximal end of the frusto-conical seal and an elasticity thereof accommodates cable end sizes in a range of from one-quarter to seven-eights inch.
